(19) United States
(12) Patent Application Publication
(10) Pub. No.: US 2025/0146968 A1
(43) Pub. Date: May 8, 2025

(54) SENSOR

(71) Applicant: KABUSHIKI KAISHA TOSHIBA, Tokyo (JP)

(72) Inventors: Naoki HIRAMATSU, Yokohama Kanagawa (JP); Hideyuki TOMIZAWA, Kita Tokyo (JP); Hiroaki YAMAZAKI, Yokohama Kanagawa (JP)

(73) Assignee: KABUSHIKI KAISHA TOSHIBA, Tokyo (JP)

(21) Appl. No.: 18/733,074

(22) Filed: Jun. 4, 2024

(30) Foreign Application Priority Data
Nov. 8, 2023 (JP) 2023-190832

(51) Int. Cl. G01N 27/22

(52) U.S. Cl. CPC G01N 27/227

(57) ABSTRACT

According to one embodiment, a sensor includes a base, a fixed portion fixed to the base, and an element portion. The fixed portion includes a first wiring fixed portion and a first fixed portion. The element portion includes a first wiring portion supported by the first wiring fixed portion and including a first wiring, a first support member supported by the first fixed portion, a first intermediate member connected to the first wiring portion and the first support member, and a movable portion connected to the first intermediate member. The movable portion includes a first movable conductive layer electrically connected to the first wiring. A first gap is provided between the base and the element portion. A second direction from the first wiring fixed portion to the first intermediate member crosses a first direction from the base to the first wiring fixed portion.

### CROSS-REFERENCE TO RELATED APPLICATIONS

This application is based upon and claims the benefit of priority from Japanese Patent Application No. 2023-190832, filed on Nov. 8, 2023; the entire contents of which are incorporated herein by reference.

### FIELD

Embodiments described herein relate generally to a sensor.

### BACKGROUND

For example, gas or the like is detected by a sensor having a MEMS (Micro Electro Mechanical Systems) structure. It is desired to improve the characteristics of sensors.

### BRIEF DESCRIPTION OF THE DRAWINGS

FIG. 1 is a schematic plan view illustrating a sensor according to a first embodiment;

FIG. 2 is a schematic cross-sectional view illustrating the sensor according to the first embodiment;

FIG. 3 is a schematic plan view illustrating a sensor according to the first embodiment;

FIG. 4 is a schematic plan view illustrating a sensor according to the first embodiment;

FIG. 5 is a schematic plan view illustrating a sensor according to the first embodiment;

FIG. 6 is a schematic plan view illustrating a sensor according to the first embodiment;

FIG. 7 is a schematic plan view illustrating a sensor according to a second embodiment;

FIG. 8 is a schematic plan view illustrating a sensor according to a third embodiment;

FIG. 9 is a schematic cross-sectional view illustrating the sensor according to the third embodiment; and

FIG. 10 is a schematic plan view illustrating a sensor according to the third embodiment.

### DETAILED DESCRIPTION

According to one embodiment, a sensor includes a base, a fixed portion fixed to the base, and an element portion. The fixed portion includes a first wiring fixed portion and a first fixed portion. The element portion includes a first wiring portion supported by the first wiring fixed portion and including a first wiring, a first support member supported by the first fixed portion, a first intermediate member connected to the first wiring portion and the first support member, and a movable portion connected to the first intermediate member. The movable portion includes a first movable conductive layer electrically connected to the first wiring. A first gap is provided between the base and the element portion. A second direction from the first wiring fixed portion to the first intermediate member crosses a first direction from the base to the first wiring fixed portion. The first wiring portion includes a first portion connected to the first wiring fixed portion, a first intermediate portion connected to the first portion, a first other intermediate portion connected to the first intermediate portion, and a first other portion connected to the first other intermediate portion. A direction from the first intermediate portion to the first portion is along the second direction. A direction from the first intermediate portion to the first other intermediate portion is along a third direction crossing a plane including the first direction and the second direction. A direction from the first other intermediate portion to the first other portion is along the second direction. The first other portion is connected to the first intermediate member.

Various embodiments are described below with reference to the accompanying drawings.

The drawings are schematic and conceptual; and the relationships between the thickness and width of portions, the proportions of sizes among portions, etc., are not necessarily the same as the actual values. The dimensions and proportions may be illustrated differently among drawings, even for identical portions.

In the specification and drawings, components similar to those described previously or illustrated in an antecedent drawing are marked with like reference numerals, and a detailed description is omitted as appropriate.

### First Embodiment

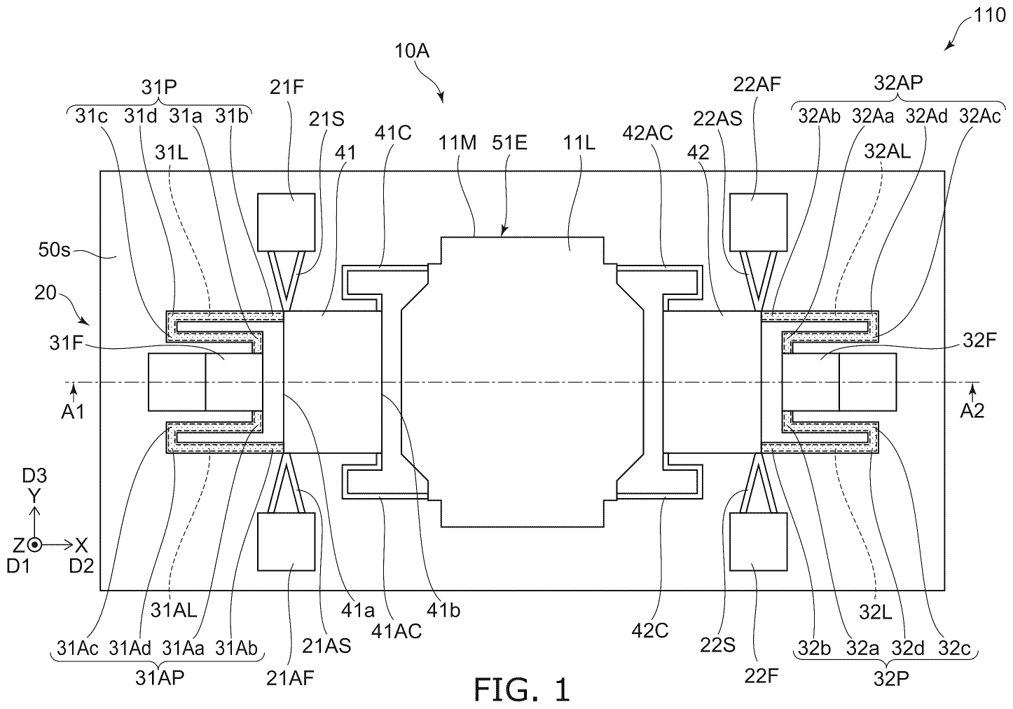

FIG. 1 is a schematic plan view illustrating a sensor according to a first embodiment.

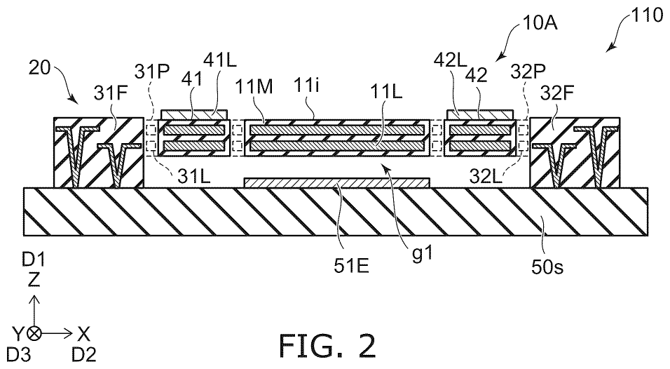

FIG. 2 is a schematic cross-sectional view illustrating the sensor according to the first embodiment.

FIG. 2 is a sectional view taken along the line A1-A2 in FIG. 1. As shown in FIGS. 1 and 2, a sensor 110 according to the embodiment includes a base 50s, a fixed portion 20, and an element portion 10A. The fixed portion 20 is fixed to the base 50s. In this example, the sensor 110 includes a fixed electrode 51E. The fixed electrode 51E is fixed to the base 50s.

The fixed portion 20 includes a first wiring fixed portion 31F and a first fixed portion 21F. The element portion 10A includes a first wiring portion 31P, a first support member 21S, a first intermediate member 41, and a movable portion 11M. The first wiring portion 31P is supported by the first wiring fixed portion 31F. The first wiring portion 31P includes a first wiring 31L. The first support member 21S is supported by the first fixed portion 21F. The first intermediate member 41 is connected to the first wiring portion 31P and the first support member 21S. The movable portion 11M is connected to the first intermediate member 41. The movable portion 11M includes a first movable conductive layer 11L. The first movable conductive layer 11L is electrically connected to the first wiring 31L.

As shown in FIG. 2, a first gap g1 is provided between the base 50s and the element portion 10A. A second direction D2 from the first wiring fixed portion 31F to the first intermediate member 41 crosses a first direction D1 from the base 50s to the first wiring fixed portion 31F.

The first direction D1 is defined as a Z-axis direction. A direction perpendicular to the Z-axis direction is defined as an X-axis direction. A direction perpendicular to the Z-axis direction and the X-axis direction is defined as a Y-axis direction. The second direction D2 may be, for example, the X-axis direction. As shown in FIG. 1, the first wiring portion 31P includes a first portion 31a, a first intermediate portion 31c, a first other intermediate portion 31d, and a first other portion 31b. The first portion 31a is connected to the first wiring fixed portion 31F. The first intermediate portion 31c is connected to the first portion 31a. The first other intermediate portion 31d is connected to the first intermediate portion 31c. The first other portion 31b is connected to the first other intermediate portion 31d.

A direction from the first intermediate portion 31c to the first portion 31a is along the second direction D2. A direction from the first intermediate portion 31c to the first other intermediate portion 31d is along a third direction D3. The third direction D3 crosses a plane including the first direction D1 and the second direction D2. The direction from the first other intermediate portion 31d to the first other portion 31b is along the second direction D2. The first other portion 31b is connected to the first intermediate member 41.

In the sensor 110, the movable portion 11M is supported by the first fixed portion 21F via the first intermediate member 41. The first movable conductive layer 11L included in the movable portion 11M is drawn to the outside via the first wiring 31L included in the first wiring portion 31P.

For example, stress of the first wiring portion 31P may change due to the influence of the current flowing through the first wiring 31L. The stress may also occur due to manufacturing processes or the like. Under the influence of the generated stress, the first intermediate member 41 may be deformed or displaced, and unintended displacement may occur in the movable portion 11M.

In the embodiment, as described above, the first wiring portion 31P includes the first portion 31a, the first intermediate portion 31c, the first other intermediate portion 31d, and the first other portion 31b. With such a structure, the first wiring portion 31P becomes soft. Thereby, even when stress occurs in the first wiring portion 31P, the influence on the first intermediate member 41 is suppressed. Thereby, unintended displacement in the movable portion 11M can be suppressed. Stable operation can be obtained. For example, highly accurate detection becomes possible. According to the embodiment, a sensor whose characteristics can be improved can be provided.

In one example, the first intermediate member 41 deforms depending on the detection target around the element portion 10A. For example, the volume of a part of the first intermediate member 41 changes depending on the detection target (gas, etc.). As a result, the first intermediate member 41 is deformed. As the first intermediate member 41 deforms, the movable portion 11M is displaced. For example, the distance between the fixed electrode 51E and the first movable conductive layer 11L changes. This changes the capacitance between the fixed electrode 51E and the first movable conductive layer 11L. The detection target can be detected by detecting changes in capacitance. The sensor 110 is, for example, a gas sensor.

The displacement of the movable portion 11M may be detected optically, for example. In this case, the fixed electrode 51E may be omitted. In this case, the first movable conductive layer 11L included in the movable portion 11M may function as, for example, a heater for removing unnecessary substances (such as water).

As shown in FIG. 2, the first intermediate member 41 may include a first intermediate member layer 41L. The first intermediate member layer 41L may include, for example, at least one selected from the group consisting of Pd and Pt. The first intermediate member layer 41L functions as a catalyst, for example. The first intermediate member layer 41L may further include Si and Cu, for example. The first intermediate member layer 41L may include, for example, PdCuSi or the like. For example, hydrogen can be stored.

As described above, the first wiring portion 31P includes the first portion 31a, the first intermediate portion 31c, the first other intermediate portion 31d, and the first other portion 31b. The first wiring portion 31P includes a folded structure. The number of folded structures is arbitrary. This makes the first wiring portion 31P soft. For example, the first wiring portion 31P has a meandering structure with large folds. Due to the folded structure, for example, even when the first wiring portion 31P has a warp, the displacement caused by the warp can be reduced.

For example, the spring constant of the first wiring portion 31P (first wiring portion spring constant) is smaller than the spring constant of the first support member 21S (first support member spring constant).

As shown in FIG. 1, a position of at least a part of the first wiring fixed portion 31F in the second direction D2 is between a position of the first intermediate portion 31c in the second direction D2, and a position of the first intermediate member 41 in the second direction D2. A long distance folded structure is applied. The spring constant can be made smaller. As shown in FIG. 1, the first support member 21S may extend linearly. A large spring constant can be easily obtained in the first support member 21S.

As shown in FIG. 1, a direction from the first intermediate member 41 to the first support member 21S crosses the first direction D1 and crosses the second direction D2.

As shown in FIG. 1, the first intermediate member 41 includes a first intermediate region 41a and a first other intermediate region 41b. The first other intermediate region 41b is located between the first intermediate region 41a and the movable portion 11M. The movable portion 11M is connected to the first other intermediate region 41b. The first wiring portion 31P and the first support member 21S are connected to the first intermediate region 41a.

As shown in FIG. 1, the fixed portion 20 may further include a second wiring fixed portion 32F and a second fixed portion 22F. The element portion 10A may further include a second wiring portion 32P, a second support member 22S, and a second intermediate member 42. The second wiring portion 32P is supported by the second wiring fixed portion 32F and includes a second wiring 32L. The second support member 22S is supported by the second fixed portion 22F. The second intermediate member 42 is connected to the second wiring portion 32P and the second support member 22S. The second wiring 32L may be electrically connected to a conductive layer included in the movable portion 11M.

The movable portion 11M is provided between the first intermediate member 41 and the second intermediate member 42. A direction from the second intermediate member 42 to the second wiring fixed portion 32F is along the second direction D2.

The second wiring portion 32P includes a second portion 32a, a second intermediate portion 32c, a second other intermediate portion 32d, and a second other portion 32b. The second portion 32a is connected to the second wiring fixed portion 32F. The second intermediate portion 32c is connected to the second portion 32a. The second other intermediate portion 32d is connected to the second intermediate portion 32c. The second other portion 32b is connected to the second other intermediate portion 32d.

A direction from the second portion 32a to the second intermediate portion 32c is along the second direction D2. A direction from the second other intermediate portion 32d to the second intermediate portion 32c is along the third direction D3. A direction from the second other portion 32b to the second other intermediate portion 32d is along the second direction D2. The second other portion 32b is connected to the second intermediate member 42.

A small spring constant is obtained in the second wiring portion 32P. For example, the spring constant of the second wiring portion 32P is smaller than the spring constant of the second support member 22S.

As shown in FIG. 2, the second intermediate member 42 may include a second intermediate member layer 42L. The second intermediate member layer 42L may include, for example, the same material as the first intermediate member layer 41L.

As shown in FIG. 1, the fixed portion 20 may further include a first opposing fixed portion 21AF. The element portion 10A may further include a first opposing wiring portion 31AP and a first opposing support member 21AS. The first opposing wiring portion 31AP is supported by the first wiring fixed portion 31F and includes a first opposing wiring 31AL. The first opposing support member 21AS is supported by the first opposing fixed portion 21AF. The first opposing wiring 31AL may be electrically connected to a conductive layer included in the movable portion 11M.

The first intermediate member 41 is connected to the first opposing wiring portion 31AP and the first opposing support member 21AS. The first intermediate member 41 is provided between the first opposing support member 21AS and the first support member 21S in the third direction D3.

As shown in FIG. 1, the first opposing wiring portion 31AP includes a first opposing portion 31Aa, a first opposing intermediate portion 31Ac, a first opposing other intermediate portion 31Ad, and a first opposing other portion 31Ab. The first opposing portion 31Aa is connected to the first wiring fixed portion 31F. The first opposing intermediate portion 31Ac is connected to the first opposing portion 31Aa. The first opposing other intermediate portion 31Ad is connected to the first opposing intermediate portion 31Ac. The first opposing other portion 31Ab is connected to the first opposing other intermediate portion 31Ad.

A direction from the first opposing intermediate portion 31Ac to the first opposing portion 31Aa is along the second direction D2. A direction from the first opposing other intermediate portion 31Ad to the first opposing intermediate portion 31Ac is along the third direction D3. A direction from the first opposing other intermediate portion 31Ad to the first opposing other portion 31Ab is along the second direction D2. The first opposing other portion 31Ab is connected to the first intermediate member 41.

A small spring constant can be obtained in the first opposing wiring portion 31AP. For example, the spring constant of the first opposing wiring portion 31AP is smaller than the spring constant of the first opposing support member 21AS.

As shown in FIG. 1, the fixed portion 20 may further include a second opposing fixed portion 22AF. The element portion 10A may include a second opposing wiring portion 32AP and a second opposing support member 22AS. The second opposing wiring portion 32AP is supported by the second wiring fixed portion 32F, and may include a second opposing wiring 32AL. The second opposing support member 22AS is supported by the second opposing fixed portion 22AF. The second opposing wiring 32AL may be electrically connected to a conductive layer included in the movable portion 11M.

The second intermediate member 42 is connected to the second opposing wiring portion 32AP and the second opposing support member 22AS. The second intermediate member 42 is provided between the second support member 22S and the second opposing support member 22AS in the third direction D3. The second opposing wiring portion 32AP includes a second opposing portion 32Aa, a second opposing intermediate portion 32Ac, a second opposing other intermediate portion 32Ad, and a second opposing other portion 32Ab. The second opposing portion 32Aa is connected to the second wiring fixed portion 32F. The second opposing intermediate portion 32Ac is connected to the second opposing portion 32Aa. The second opposing other intermediate portion 32Ad is connected to the second opposing intermediate portion 32Ac. The second opposing other portion 32Ab is connected to the second opposing other intermediate portion 32Ad.

A direction from the second opposing portion 32Aa to the second opposing intermediate portion 32Ac is along the second direction D2. A direction from the second opposing intermediate portion 32Ac to the second opposing other intermediate portion 32Ad is along the third direction D3. A direction from the second opposing other portion 32Ab to the second opposing other intermediate portion 32Ad is along the second direction D2. The second opposing other portion 32Ab is connected to the second intermediate member 42.

A small spring constant can be obtained in the second opposing wiring portion 32AP. For example, the spring constant of the second opposing wiring portion 32AP is smaller than the spring constant of the second opposing support member 22AS. As shown in FIG. 1, the element portion 10A may further include a first connecting member 41C. The first connecting member 41C is supported by the first intermediate member 41. The first connecting member 41C supports the movable portion 11M.

As shown in FIG. 1, the element portion 10A may further include a second connecting member 42C. The second connecting member 42C is supported by the second intermediate member 42. The second connecting member 42C supports the movable portion 11M.

As shown in FIG. 1, the element portion 10A may further include a first other connecting member 41AC. The first other connecting member 41AC is supported by the first intermediate member 41. The first other connecting member 41AC supports the movable portion 11M.

As shown in FIG. 1, the element portion 10A may further include a second other connecting member 42AC. The second other connecting member 42AC is supported by the second intermediate member 42. The second other connecting member 42AC supports the movable portion 11M.

As shown in FIG. 2, the element portion 10A may include an insulating member 11i. The insulating member 11i is provided around the first movable conductive layer 11L, for example. The insulating member 11i is provided at the first wiring portion 31P and the like.

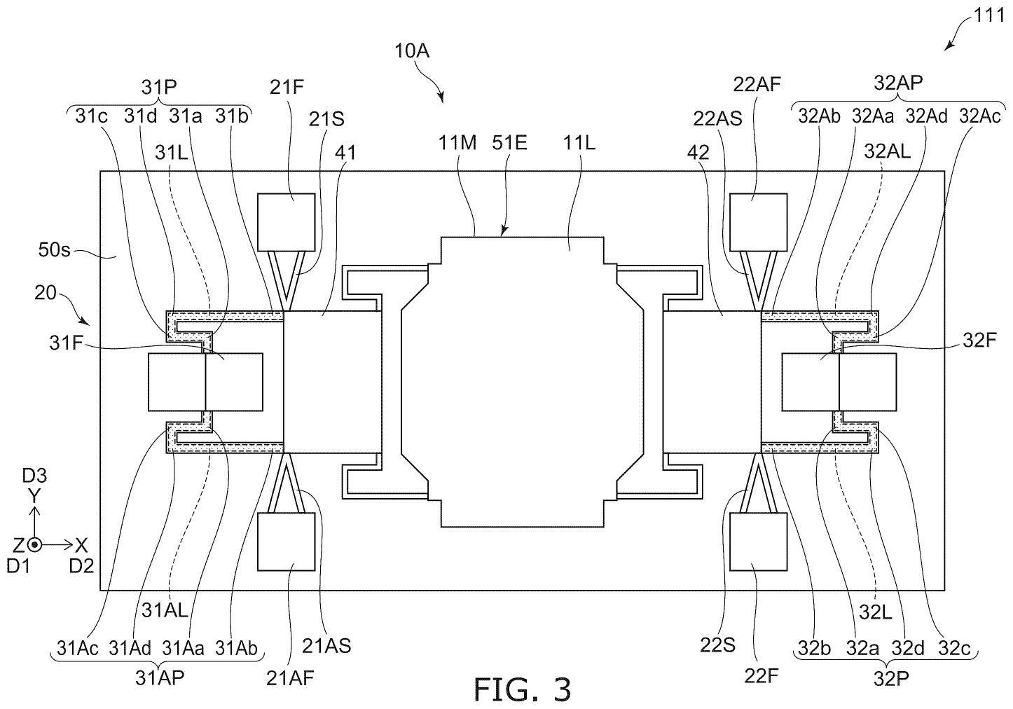

FIG. 3 is a schematic plan view illustrating a sensor according to the first embodiment.

As shown in FIG. 3, in a sensor 111 according to the embodiment, the position where the wiring portion (for example, the first wiring portion 31P) and the wiring fixed portion (for example, the first wiring fixed portion 31F) are connected is different from the position in the sensor 110. The configuration of the sensor 111 except for this may be the same as the configuration of the sensor 110.

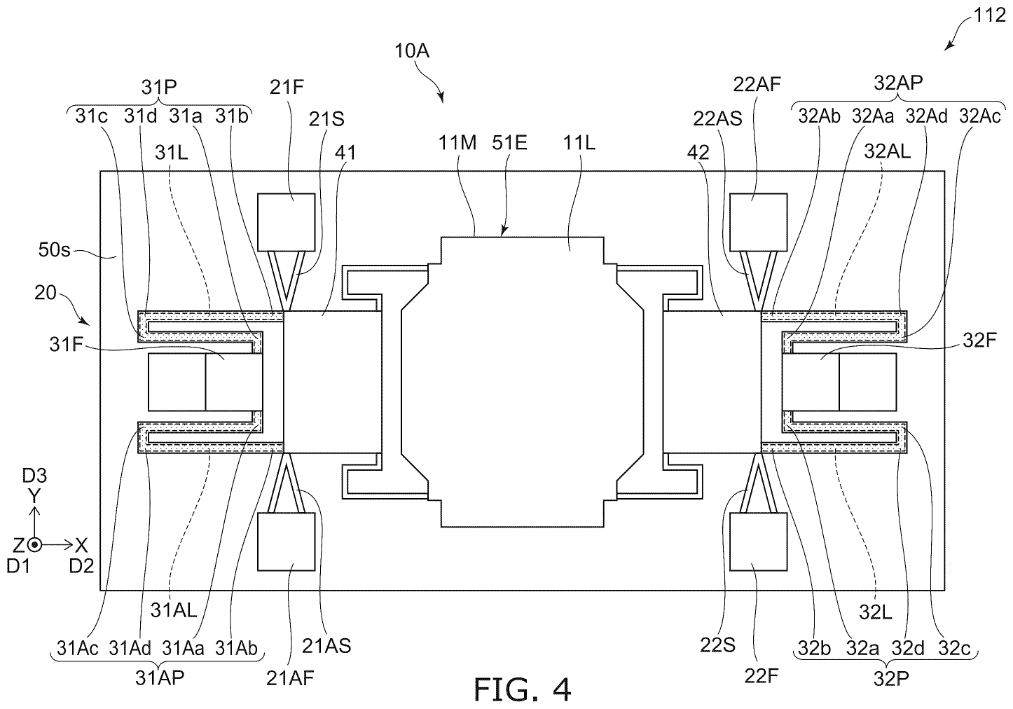

FIG. 4 is a schematic plan view illustrating a sensor according to the first embodiment.

As shown in FIG. 4, in a sensor 112 according to the embodiment, the shape of the wiring portion (for example, the first wiring portion 31P) is different from the shape in the sensor 110. The configuration of the sensor 112 except for this may be the same as the configuration of the sensor 110.

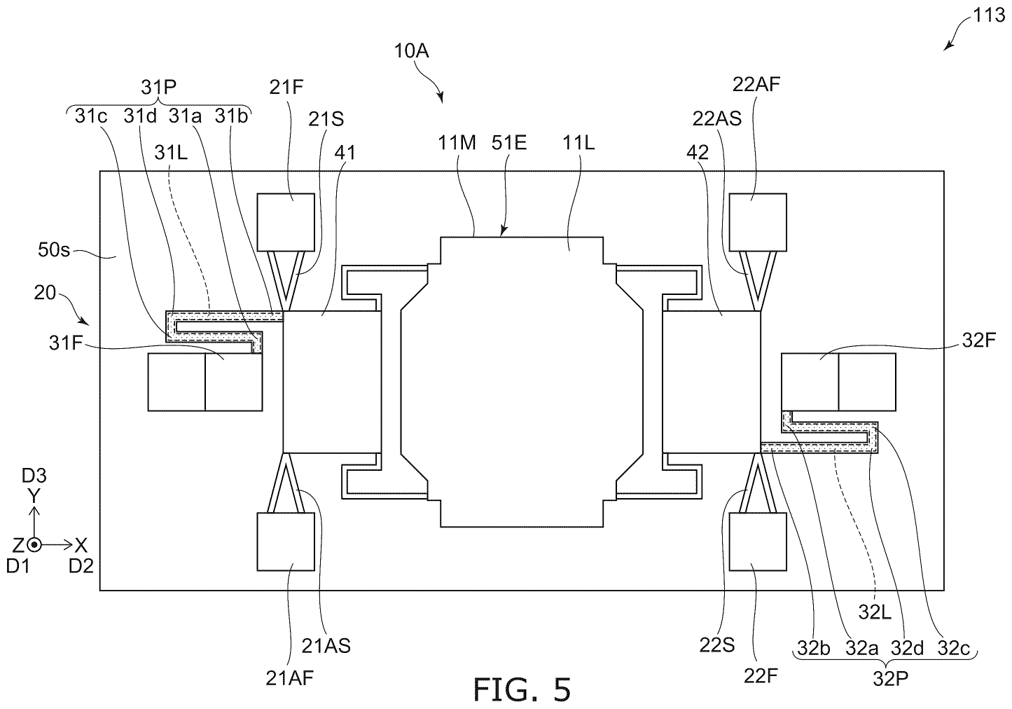

FIG. 5 is a schematic plan view illustrating a sensor according to the first embodiment.

As shown in FIG. 5, in a sensor 113 according to the embodiment, the first opposing wiring portion 31AP and the second opposing wiring portion 32AP are omitted. The configuration of the sensor 113 except for this may be the same as the configuration of the sensor 110.

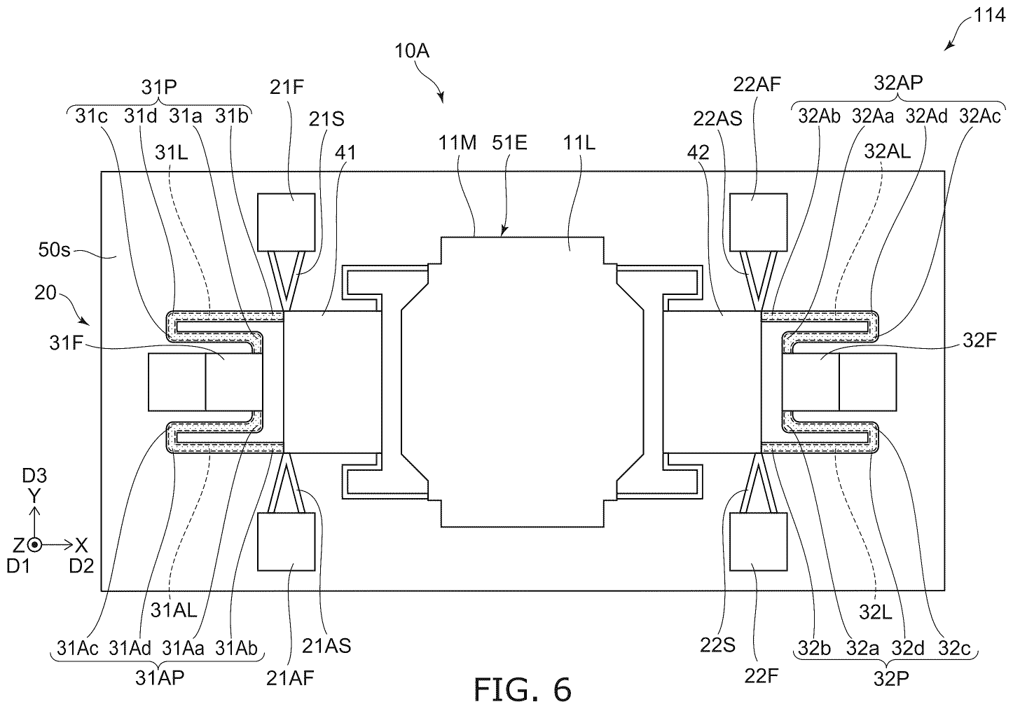

FIG. 6 is a schematic plan view illustrating a sensor according to the first embodiment.

As shown in FIG. 6, in a sensor 114 according to the embodiment, the folded portion in the wiring portion (for example, the first wiring portion 31P) has a curved shape. The configuration of the sensor 114 except for this may be the same as the configuration of the sensor 110. Also in the sensor 111, the sensor 112, the sensor 113, and the sensor 114, unintended displacement in the movable portion 11M can be suppressed. Stable operation can be obtained. For example, highly accurate detection becomes possible. According to the embodiment, a sensor whose characteristics can be improved is provided.

### Second Embodiment

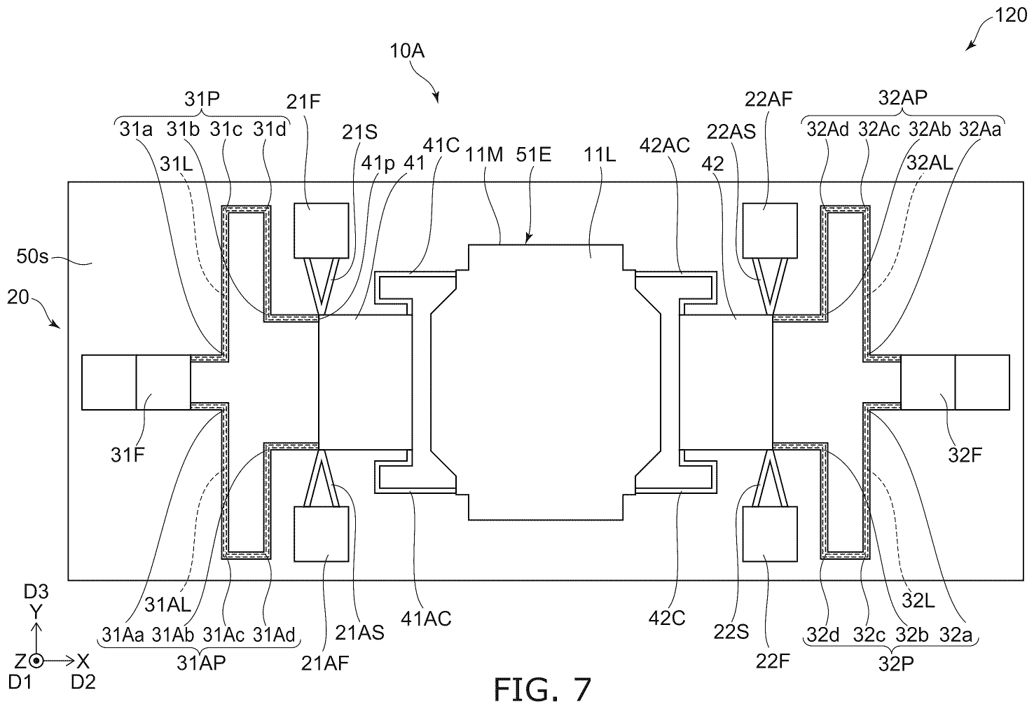

FIG. 7 is a schematic plan view illustrating a sensor according to the second embodiment.

As shown in FIG. 7, a sensor 120 according to the embodiment includes the base 50s, the fixed portion 20 fixed to the base 50s, and the element portion 10A. The cross-sectional structure of the sensor 120 may be similar to the cross-sectional structure described with reference to FIG. 2.

The fixed portion 20 includes the first wiring fixed portion 31F and the first fixed portion 21F. The element portion 10A includes the first wiring portion 31P supported by the first wiring fixed portion 31F and including the first wiring 31L, the first support member 21S supported by the first fixed portion 21F, the first intermediate member 41 connected to the first wiring portion 31P and the first support member 21S, and a movable portion. The movable portion 11M is connected to the first intermediate member 41. The movable portion 11M includes the first movable conductive layer 11L electrically connected to the first wiring 31L (see FIG. 2). The first gap g1 is provided between the base 50s and the element portion 10A (see FIG. 2).

In the sensor 120, the second direction D2 from the first wiring fixed portion 31F to the first intermediate member 41 crosses the first direction D1 from the base 50s to the first wiring fixed portion 31F.

The first wiring portion 31P includes the first portion 31a connected to the first wiring fixed portion 31F, the first intermediate portion 31c connected to the first portion 31a, and a first other intermediate portion 31d connected to the first intermediate portion 31c, and the first other portion 31b connected to the first other intermediate portion 31d.

In the sensor 120, the direction from the first portion 31a to the first intermediate portion 31c is along a third direction D3 that crosses a plane including the first direction D1 and the second direction D2. The direction from the first intermediate portion 31c to the first other intermediate portion 31d is along the second direction D2. The direction from the first other portion 31b to the first other intermediate portion 31d is along the second direction D2. The first other portion 31b is connected to the first intermediate member 41.

The first intermediate member 41 includes a first connecting region 41p connected to the first other portion 31b. A position of the first connecting region 41p in the third direction D3 is between a position of the first portion 31a in the third direction D3 and a position of the first other intermediate portion 31d in the third direction D3.

A small spring constant can be obtained in the first wiring portion 31P having such a structure. For example, the spring constant of the first wiring portion 31P is smaller than the spring constant of the first support member 21S. In the sensor 120, for example, unintended displacement in the movable portion 11M can be suppressed. Stable operation can be obtained. For example, highly accurate detection becomes possible. According to the embodiment, a sensor whose characteristics can be improved can be provided.

In the sensor 120 as well, the element portion 10A may include the second wiring portion 32P, the first opposing wiring portion 31AP, and the second opposing wiring portion 32AP. These wiring portions in the sensor 120 may have the same configuration as the first wiring portion 31P in the sensor 120.

For example, in the sensor 120, the element portion 10A may further include the first connecting member 41C. The first connecting member 41C is supported by the first intermediate member 41. The first connecting member 41C supports the movable portion 11M.

In the first embodiment and the second embodiment, for example, the length of the first wiring portion 31P along the path along which the first wiring portion 31P extends (first wiring portion) is the same as the length along the path along which the first support member 21S extends. The length of the first support member 21S (first support member length) is longer than the length of the first support member 21S (first support member length). In the first wiring portion 31P, it is easy to obtain a small spring constant.

### Third Embodiment

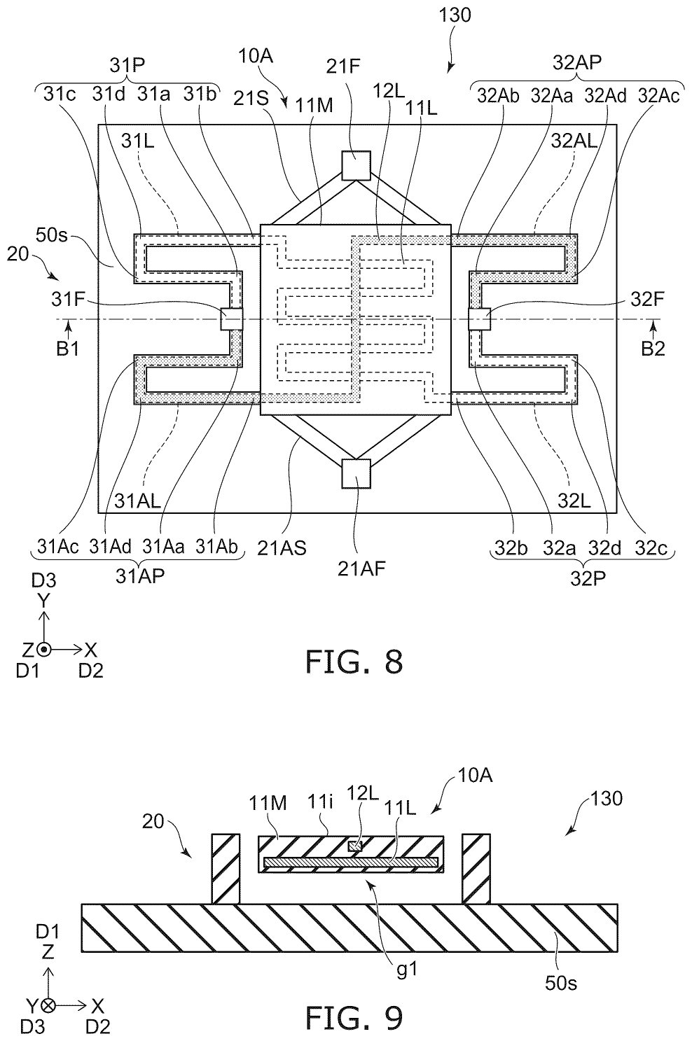

FIG. 8 is a schematic plan view illustrating a sensor according to the third embodiment.

FIG. 9 is a schematic cross-sectional view illustrating the sensor according to the third embodiment.

FIG. 9 is a sectional view taken along the line B1-B2 in FIG. 8.

As shown in FIGS. 8 and 9, a sensor 130 according to the embodiment includes the base 50s, the fixed portion 20, and the element portion 10A. The fixed portion 20 is fixed to the base 50s.

The fixed portion 20 includes the first wiring fixed portion 31F and the first fixed portion 21F. The element portion 10A includes the first wiring portion 31P, the first support member 21S, and the movable portion 11M. The first wiring portion 31P is supported by the first wiring fixed portion 31F and includes the first wiring 31L. The first support member 21S is supported by the first fixed portion 21F. The movable portion 11M is connected to the first wiring portion 31P and the first support member 21S. The movable portion 11M includes the first movable conductive layer 11L electrically connected to the first wiring 31L. The first gap g1 is provided between the base 50s and the element portion 10A.

The second direction D2 from the first wiring fixed portion 31F to the movable portion 11M crosses the first direction D1 from the base 50s to the first wiring fixed portion 31F. The first direction D1 is, for example, the Z-axis direction. The second direction D2 is, for example, the X-axis direction.

The first wiring portion 31P includes the first portion 31a connected to the first wiring fixed portion 31F, the first intermediate portion 31c connected to the first portion 31a, and the first other intermediate portion 31d connected to the first intermediate portion 31c, and the first other portion 31b connected to the first other intermediate portion 31d.

The direction from the first intermediate portion 31c to the first portion 31a is along the second direction D2. The direction from the first intermediate portion 31c to the first other intermediate portion 31d is along the third direction D3 that crosses a plane including the first direction D1 and the second direction D2. The third direction D3 is, for example, the Y-axis direction. The direction from the first other intermediate portion 31d to the first other portion 31b is along the second direction D2. The first other portion 31b is connected to the movable portion 11M.

In the sensor 130 as well, a small spring constant can be obtained in the first wiring portion 31P. For example, the spring constant of the first wiring portion 31P is smaller than the spring constant of the first support member 21S. In the sensor 130, for example, unintended displacement in the movable portion 11M can be suppressed. Stable operation can be obtained. For example, highly accurate detection becomes possible. According to the embodiment, a sensor whose characteristics can be improved can be provided.

In the sensor 130, the temperature state of the movable portion 11M changes depending on the detection target around the element portion 10A. For example, heat conduction occurs due to the detection target (e.g., gas, etc.). Heat dissipation properties change depending on the type and concentration of the detection target. The temperature of the movable portion 11M changes in accordance with the change in heat dissipation. For example, the first movable conductive layer 11L may function as a heater. The temperature of the movable portion 11M increases by the heater. The temperature of the movable portion 11M changes depending on the detection target.

In embodiments, detecting a change in temperature may be performed in any manner. In one example, the temperature of the movable portion 11M may be detected by an infrared temperature sensor or the like. In another example, a resistive layer may be provided for temperature sensing.

As shown in FIGS. 8 and 9, in this example, the movable portion 11M further includes a second movable conductive layer 12L. The electrical resistance of the second movable conductive layer 12L changes depending on the detection target. The second movable conductive layer 12L functions as a resistance element, for example. By detecting a change in the resistance of the second movable conductive layer 12L, a change in temperature of the movable portion 11M can be detected. The detection target can be detected by detecting a change in resistance of the second movable conductive layer 12L. In this example, the second movable conductive layer 12L is connected to an external circuit via the first opposing wiring 31AL. The sensor 130 functions, for example, as a thermal conduction type sensor. The sensor 130 functions as a resistance type sensor, for example.

In the sensor 130, the second movable conductive layer 12L may be a catalyst layer capable of reacting with the detection target. In this case, the second movable conductive layer 12L (catalyst layer) may be provided with a large area so as to cover the first movable conductive layer 11L. In this case, the sensor 130 functions as, for example, a reducing gas combustion reaction type sensor. In one example, the second movable conductive layer 12L (catalyst layer) may be exposed.

In the sensor 130 as well, the element portion 10A may include the second wiring portion 32P, the first opposing wiring portion 31AP, and the second opposing wiring portion 32AP. These wiring portions in the sensor 130 may have the same configuration as the first wiring portion 31P in the sensor 120.

For example, in the sensor 130, the element portion 10A may further include the first connecting member 41C. The first connecting member 41C is supported by the first intermediate member 41. The first connecting member 41C supports the movable portion 11M.

In the third embodiment, for example, the length (first wiring length) of the first wiring portion 31P along the path in which the first wiring portion 31P extends is longer than the length (first support member length) of the first support member 21S along the path in which the first support member 21S extends. In the first wiring portion 31P, it is easy to obtain a small spring constant.

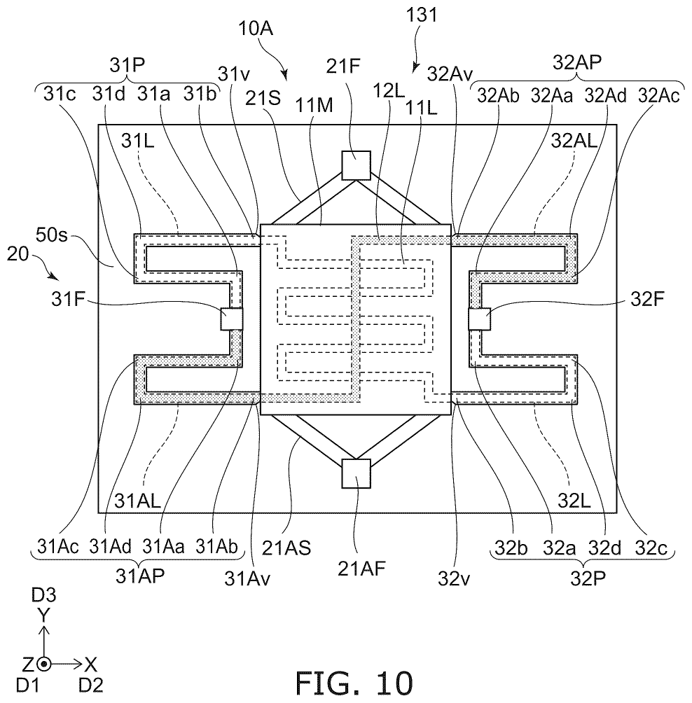

FIG. 10 is a schematic plan view illustrating a sensor according to the third embodiment.

As shown in FIG. 10, in a sensor 131 according to the embodiment, a recess is provided in the wiring portion. The configuration of the sensor 131 except for this may be the same as the configuration of the sensor 130.

In the sensor 131, for example, the first wiring portion 31P includes a first recess 31v. This makes the movable portion 11M less susceptible to the stress of the first wiring portion 31P. The second wiring portion 32P may include a second recess 32v. The first opposing wiring portion 31AP may include a first opposing recess 31Av. The second opposing wiring portion 32AP may include a second opposing recess 32Av.

The embodiments may include the following Technical proposals:

### (Technical Proposal 1)

A sensor, comprising:
a base;
a fixed portion fixed to the base; and
an element portion,
the fixed portion including a first wiring fixed portion and a first fixed portion,
the element portion including:
   a first wiring portion supported by the first wiring fixed portion and including a first wiring,
   a first support member supported by the first fixed portion,
   a first intermediate member connected to the first wiring portion and the first support member, and
   a movable portion connected to the first intermediate member, the movable portion including a first movable conductive layer electrically connected to the first wiring,
a first gap being provided between the base and the element portion,
a second direction from the first wiring fixed portion to the first intermediate member crossing a first direction from the base to the first wiring fixed portion,
the first wiring portion including:
   a first portion connected to the first wiring fixed portion,
   a first intermediate portion connected to the first portion,
   a first other intermediate portion connected to the first intermediate portion, and
   a first other portion connected to the first other intermediate portion,
a direction from the first intermediate portion to the first portion being along the second direction,
a direction from the first intermediate portion to the first other intermediate portion being along a third direction crossing a plane including the first direction and the second direction,
a direction from the first other intermediate portion to the first other portion being along the second direction, and
the first other portion being connected to the first intermediate member.

### (Technical Proposal 2)

The sensor according to Technical proposal 1, wherein
a direction from the first intermediate member to the first support member crosses the first direction and crosses the second direction.

### (Technical Proposal 3)

The sensor according to Technical proposal 1 or 2, wherein the first support member extends linearly.

### (Technical Proposal 4)

The sensor according to any one of Technical proposals 1-3, wherein
the first intermediate member includes a first intermediate region and a first other intermediate region,
the first other intermediate region is between the first intermediate region and the movable portion,
the movable portion is connected to the first other intermediate region, and
the first wiring portion and the first support member are connected to the first intermediate region.

### (Technical Proposal 5)

The sensor according to any one of Technical proposals 1-4, further comprising:
a fixed electrode fixed to the base,
the first intermediate member being configured to be deformed according to a detection target around the element portion, and
a capacitance between the fixed electrode and the first movable conductive layer being configured to be changed.

### (Technical Proposal 6)

The sensor according to Technical proposal 5, wherein
the first intermediate member includes a first intermediate member layer, and
the first intermediate member layer includes at least one selected from the group consisting of Pd and Pt.

### (Technical Proposal 7)

The sensor according to Technical proposal 6, wherein the first intermediate member layer further includes Si and Cu.

### (Technical Proposal 8)

The sensor according to any one of Technical proposals 1-7, wherein
a first wiring portion spring constant of the first wiring portion is smaller than a first support member spring constant of the first support member.

### (Technical Proposal 9)

The sensor according to any one of Technical proposals 5-8, wherein
a position of at least a part of the first wiring fixed portion in the second direction is between a position of the first intermediate portion in the second direction and a position of the first intermediate member in the second direction.

### (Technical Proposal 10)

The sensor according to any one of Technical proposals 5-9, wherein
the fixed portion further includes a second wiring fixed portion and a second fixed portion,
the element portion includes:
   a second wiring portion supported by the second wiring fixed portion and including a second wiring,
   a second support member supported by the second fixed portion,
   a second intermediate member connected to the second wiring portion and the second support member,
the movable portion is provided between the first intermediate member and the second intermediate member,
a direction from the second intermediate member to the second wiring fixed portion is along the second direction,
the second wiring portion includes:
   a second portion connected to the second wiring fixed portion,
   a second intermediate portion connected to the second portion,
   a second other intermediate portion connected to the second intermediate portion, and
   a second other portion connected to the second other intermediate portion,
   a direction from the second portion to the second intermediate portion is along the second direction,
a direction from the second other intermediate portion to the second intermediate portion is along the third direction,
a direction from the second other portion to the second other intermediate portion is along the second direction, and
the second other portion is connected to the second intermediate member.

### (Technical Proposal 11)

The sensor according to Technical proposal 10, wherein
the fixed portion further includes a first opposing fixed portion,
the element portion includes:
   a first opposing wiring portion supported by the first wiring fixed portion and including a first opposing wiring, and
   a first opposing support member supported by the first opposing fixed portion,
the first intermediate member is connected to the first opposing wiring portion and the first opposing support member,
the first intermediate member is provided between the first opposing support member and the first support member in the third direction,
the first opposing wiring portion includes:
   a first opposing portion connected to the first wiring fixed portion,
   a first opposing intermediate portion connected to the first opposing portion,
   a first opposing other intermediate portion connected to the first opposing intermediate portion, and
   a first opposing other portion connected to the first opposing other intermediate portion,
a direction from the first opposing intermediate portion to the first opposing portion is along the second direction,
a direction from the first opposing other intermediate portion to the first opposing intermediate portion is along the third direction,
a direction from the first opposing other intermediate portion to the first opposing other portion is along the second direction, and
the first opposing other portion is connected to the first intermediate member.

### (Technical Proposal 12)

The sensor according to Technical proposal 11, wherein
the fixed portion further includes a second opposing fixed portion,
the element portion includes:
   a second opposing wiring portion supported by the second wiring fixed portion and including a second opposing wiring, and
   a second opposing support member supported by the second opposing fixed,
the second intermediate member is connected to the second opposing wiring portion and the second opposing support member,
the second intermediate member is provided between the second support member and the second opposing support member in the third direction,
the second opposing wiring portion includes:
   a second opposing portion connected to the second wiring fixed portion,
   a second opposing intermediate portion connected to the second opposing portion,
   a second opposing other intermediate portion connected to the second opposing intermediate portion, and
   a second opposing other portion connected to the second opposing other intermediate portion,
   a direction from the second opposing portion to the second opposing intermediate portion is along the second direction,
a direction from the second opposing intermediate portion to the second opposing other intermediate portion is along the third direction,
a direction from the second opposing other portion to the second opposing other intermediate portion is along the second direction, and
the second opposing other portion is connected to the second intermediate member.

### (Technical Proposal 13)

A sensor, comprising:
a base;
a fixed portion fixed to the base; and
an element portion,
the fixed portion including a first wiring fixed portion and a first fixed portion,
the element portion including:
   a first wiring portion supported by the first wiring fixed portion and including a first wiring,
   a first support member supported by the first fixed portion,
   a first intermediate member connected to the first wiring portion and the first support member, and
   a movable portion connected to the first intermediate member, the movable portion including a first movable conductive layer electrically connected to the first wiring, including,
a first gap being provided between the base and the element portion,
a second direction from the first wiring fixed portion to the first intermediate member crossing a first direction from the base to the first wiring fixed portion,
the first wiring portion including:
   a first portion connected to the first wiring fixed portion,
   a first intermediate portion connected to the first portion,
   a first other intermediate portion connected to the first intermediate portion, and
   a first other portion connected to the first other intermediate portion,
a direction from the first portion to the first intermediate portion being along a third direction crossing a plane including the first direction and the second direction,
a direction from the first intermediate portion to the first other intermediate portion being along the second direction,
a direction from the first other portion to the first other intermediate portion being along the second direction,
the first other portion being connected to the first intermediate member,
the first intermediate member includes a first connection region connected to the first other portion, and
a position of the first connection region in the third direction being between a position of the first portion in the third direction and a position of the first intermediate portion in the third direction.

### (Technical Proposal 14)

The sensor according to any one of Technical proposals 1-13, wherein
the element section further includes a first connection member,
the first connecting member is supported by the first intermediate member, and
the first connection member supports the movable portion.

### (Technical Proposal 15)

A sensor, comprising:
a base;
a fixed portion fixed to the base; and
an element portion,
the fixed portion including a first wiring fixed portion and a first fixed portion,
the element portion including:
   a first wiring portion supported by the first wiring fixed portion and including a first wiring,
   a first support member supported by the first fixed portion, and
   a movable portion connected to the first wiring portion and the first support member, the movable portion including a first movable conductive layer electrically connected to the first wiring;
a first gap being provided between the base and the element portion,
a second direction from the first wiring fixed portion to the movable portion crossing a first direction from the base to the first wiring fixed portion,
the first wiring portion including:
   a first portion connected to the first wiring fixed portion,
   a first intermediate portion connected to the first portion,
   a first other intermediate portion connected to the first intermediate portion, and
   a first other portion connected to the first other intermediate portion,
a direction from the first intermediate portion to the first portion being along the second direction,
a direction from the first intermediate portion to the first other intermediate portion being along a third direction crossing
a plane including the first direction and the second direction, a direction from the first other intermediate portion to the first other portion being along the second direction, and
the first other portion being connected to the movable portion.

### (Technical Proposal 16)

The sensor according to Technical proposal 15, wherein
a temperature state of the movable portion is configured to be changed depending on a detection target around the element portion.

### (Technical Proposal 17)

The sensor according to Technical proposal 16, wherein
the movable portion further includes a second movable conductive layer, and
an electrical resistance of the second movable conductive layer is configured to be changed depending on the detection target.

### (Technical Proposal 18)

The sensor according to Technical proposal 16, wherein
the movable portion includes a catalyst layer configured to react with the detection target.
   (Technical proposal 19)

The sensor according to any one of Technical proposals 15-18, wherein
a first wiring portion spring constant of the first wiring portion is smaller than a first support member spring constant of the first support member.

### (Technical Proposal 20)

The sensor according to any one of Technical proposals 1-19, wherein
a first wiring portion length of the first wiring portion along a path in which the first wiring portion extends is longer than a first support member length of the first support member along a path in which the first support member extends.

According to the embodiment, a sensor whose characteristics can be improved can be provided.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, exemplary embodiments of the invention are described with reference to specific examples. However, the embodiments of the invention are not limited to these specific examples. For example, one skilled in the art may similarly practice the invention by appropriately selecting specific configurations of components included in sensors such as, bases, element portions, fixed electrodes, fixed members, wring members, support members, movable members, etc., from known art. Such practice is included in the scope of the invention to the extent that similar effects thereto are obtained.

Further, any two or more components of the specific examples may be combined within the extent of technical feasibility and are included in the scope of the invention to the extent that the purport of the invention is included.

Moreover, all sensors practicable by an appropriate design modification by one skilled in the art based on the sensors described above as embodiments of the invention also are within the scope of the invention to the extent that the purport of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A sensor, comprising:
a base;
a fixed portion fixed to the base; and
an element portion,
the fixed portion including a first wiring fixed portion and a first fixed portion,
the element portion including:
a first wiring portion supported by the first wiring fixed portion and including a first wiring,
a first support member supported by the first fixed portion,
a first intermediate member connected to the first wiring portion and the first support member, and
a movable portion connected to the first intermediate member, the movable portion including a first movable conductive layer electrically connected to the first wiring,
a first gap being provided between the base and the element portion,
a second direction from the first wiring fixed portion to the first intermediate member crossing a first direction from the base to the first wiring fixed portion,
the first wiring portion including:
a first portion connected to the first wiring fixed portion,
a first intermediate portion connected to the first portion,
a first other intermediate portion connected to the first intermediate portion, and
a first other portion connected to the first other intermediate portion,
a direction from the first intermediate portion to the first portion being along the second direction,
a direction from the first intermediate portion to the first other intermediate portion being along a third direction crossing a plane including the first direction and the second direction,
a direction from the first other intermediate portion to the first other portion being along the second direction, and
the first other portion being connected to the first intermediate member.

2. The sensor according to claim 1, wherein
a direction from the first intermediate member to the first support member crosses the first direction and crosses the second direction.

3. The sensor according to claim 1, wherein
the first support member extends linearly.

4. The sensor according to claim 1, wherein
the first intermediate member includes a first intermediate region and a first other intermediate region,
the first other intermediate region is between the first intermediate region and the movable portion,
the movable portion is connected to the first other intermediate region, and
the first wiring portion and the first support member are connected to the first intermediate region.

5. The sensor according to claim 1, further comprising:
a fixed electrode fixed to the base,
the first intermediate member being configured to be deformed according to a detection target around the element portion, and
a capacitance between the fixed electrode and the first movable conductive layer being configured to be changed.

6. The sensor according to claim 5, wherein
the first intermediate member includes a first intermediate member layer, and
the first intermediate member layer includes at least one selected from the group consisting of Pd and Pt.

7. The sensor according to claim 6, wherein
the first intermediate member layer further includes Si and Cu.

8. The sensor according to claim 1, wherein
a first wiring portion spring constant of the first wiring portion is smaller than a first support member spring constant of the first support member.

9. The sensor according to claim 5, wherein
a position of at least a part of the first wiring fixed portion in the second direction is between a position of the first intermediate portion in the second direction and a position of the first intermediate member in the second direction.

10. The sensor according to claim 5, wherein
the fixed portion further includes a second wiring fixed portion and a second fixed portion,
the element portion includes:
a second wiring portion supported by the second wiring fixed portion and including a second wiring,
a second support member supported by the second fixed portion,
a second intermediate member connected to the second wiring portion and the second support member,
the movable portion is provided between the first intermediate member and the second intermediate member,
a direction from the second intermediate member to the second wiring fixed portion is along the second direction,
the second wiring portion includes:
a second portion connected to the second wiring fixed portion,
a second intermediate portion connected to the second portion,
a second other intermediate portion connected to the second intermediate portion, and
a second other portion connected to the second other intermediate portion,
a direction from the second portion to the second intermediate portion is along the second direction,
a direction from the second other intermediate portion to the second intermediate portion is along the third direction,
a direction from the second other portion to the second other intermediate portion is along the second direction, and
the second other portion is connected to the second intermediate member.

11. The sensor according to claim 10, wherein
the fixed portion further includes a first opposing fixed portion,
the element portion includes:
a first opposing wiring portion supported by the first wiring fixed portion and including a first opposing wiring, and
a first opposing support member supported by the first opposing fixed portion,
the first intermediate member is connected to the first opposing wiring portion and the first opposing support member,
the first intermediate member is provided between the first opposing support member and the first support member in the third direction,
the first opposing wiring portion includes:
a first opposing portion connected to the first wiring fixed portion,
a first opposing intermediate portion connected to the first opposing portion,
a first opposing other intermediate portion connected to the first opposing intermediate portion, and
a first opposing other portion connected to the first opposing other intermediate portion,
a direction from the first opposing intermediate portion to the first opposing portion is along the second direction,
a direction from the first opposing other intermediate portion to the first opposing intermediate portion is along the third direction,
a direction from the first opposing other intermediate portion to the first opposing other portion is along the second direction, and
the first opposing other portion is connected to the first intermediate member.

12. The sensor according to claim 11, wherein
the fixed portion further includes a second opposing fixed portion,
the element portion includes:
a second opposing wiring portion supported by the second wiring fixed portion and including a second opposing wiring, and
a second opposing support member supported by the second opposing fixed,
the second intermediate member is connected to the second opposing wiring portion and the second opposing support member,
the second intermediate member is provided between the second support member and the second opposing support member in the third direction,
the second opposing wiring portion includes:
a second opposing portion connected to the second wiring fixed portion,
a second opposing intermediate portion connected to the second opposing portion,
a second opposing other intermediate portion connected to the second opposing intermediate portion, and
a second opposing other portion connected to the second opposing other intermediate portion,
a direction from the second opposing portion to the second opposing intermediate portion is along the second direction,
a direction from the second opposing intermediate portion to the second opposing other intermediate portion is along the third direction,
a direction from the second opposing other portion to the second opposing other intermediate portion is along the second direction, and
the second opposing other portion is connected to the second intermediate member.

13. A sensor, comprising:
a base;
a fixed portion fixed to the base; and
an element portion,
the fixed portion including a first wiring fixed portion and a first fixed portion,
the element portion including:
a first wiring portion supported by the first wiring fixed portion and including a first wiring,
a first support member supported by the first fixed portion,
a first intermediate member connected to the first wiring portion and the first support member, and
a movable portion connected to the first intermediate member, the movable portion including a first movable conductive layer electrically connected to the first wiring, including,
a first gap being provided between the base and the element portion,
a second direction from the first wiring fixed portion to the first intermediate member crossing a first direction from the base to the first wiring fixed portion,
the first wiring portion including:
a first portion connected to the first wiring fixed portion,
a first intermediate portion connected to the first portion,
a first other intermediate portion connected to the first intermediate portion, and
a first other portion connected to the first other intermediate portion,
a direction from the first portion to the first intermediate portion being along a third direction crossing a plane including the first direction and the second direction,
a direction from the first intermediate portion to the first other intermediate portion being along the second direction,
a direction from the first other portion to the first other intermediate portion being along the second direction,
the first other portion being connected to the first intermediate member,
the first intermediate member including a first connection region connected to the first other portion, and
a position of the first connection region in the third direction being between a position of the first portion in the third direction and a position of the first intermediate portion in the third direction.

14. The sensor according to claim 1, wherein
the element section further includes a first connection member,
the first connecting member is supported by the first intermediate member, and
the first connection member supports the movable portion.

15. A sensor, comprising:
a base;
a fixed portion fixed to the base; and
an element portion,
the fixed portion including a first wiring fixed portion and a first fixed portion,
the element portion including:
a first wiring portion supported by the first wiring fixed portion and including a first wiring,
a first support member supported by the first fixed portion, and
a movable portion connected to the first wiring portion and the first support member, the movable portion including a first movable conductive layer electrically connected to the first wiring;
a first gap being provided between the base and the element portion,
a second direction from the first wiring fixed portion to the movable portion crossing a first direction from the base to the first wiring fixed portion,
the first wiring portion including:
a first portion connected to the first wiring fixed portion,
a first intermediate portion connected to the first portion,
a first other intermediate portion connected to the first intermediate portion, and
a first other portion connected to the first other intermediate portion,
a direction from the first intermediate portion to the first portion being along the second direction,
a direction from the first intermediate portion to the first other intermediate portion being along a third direction crossing a plane including the first direction and the second direction,
a direction from the first other intermediate portion to the first other portion being along the second direction, and
the first other portion being connected to the movable portion.

16. The sensor according to claim 15, wherein
a temperature state of the movable portion is configured to be changed depending on a detection target around the element portion.

17. The sensor according to claim 16, wherein
the movable portion further includes a second movable conductive layer, and
an electrical resistance of the second movable conductive layer is configured to be changed depending on the detection target.

18. The sensor according to claim 16, wherein
the movable portion includes a catalyst layer configured to react with the detection target.

19. The sensor according to claim 15, wherein
a first wiring portion spring constant of the first wiring portion is smaller than a first support member spring constant of the first support member.

20. The sensor according to claim 1, wherein
a first wiring portion length of the first wiring portion along a path in which the first wiring portion extends is longer than a first support member length of the first support member along a path in which the first support member extends.
